(19) United States
(12) Patent Application Publication
(10) Pub. No.: US 2015/0106842 A1
(43) Pub. Date: Apr. 16, 2015

(54) CONTENT SUMMARIZATION SERVER, CONTENT PROVIDING SYSTEM, AND METHOD OF SUMMARIZING CONTENT

(71) Applicant: SAMSUNG ELECTRONICS CO., LTD., Suwon-si (KR)

(72) Inventor: Yong-hoon LEE, Seoul (KR)

(73) Assignee: SAMSUNG ELECTRONICS CO., LTD., Suwon-si (KR)

(21) Appl. No.: 14/511,672

(22) Filed: Oct. 10, 2014

(30) Foreign Application Priority Data
Oct. 14, 2013 (KR) 10-2013-0122142

(51) Int. Cl. H04N 21/8549; H04N 21/235; H04N 21/237; H04N 21/234

(52) U.S. Cl. CPC H04N 21/8549; H04N 21/23418; H04N 21/2353; H04N 21/237
USPC 725/32

(57) ABSTRACT

A content summarization server, a content providing system and a method for summarizing a content are provided. The method for summarizing a content in a content summarization server includes receiving information regarding a content for which a content summary request is received from a display apparatus in response to a content summary request being input from a user, acquiring caption information related to a content for which the content summary request is input based on the received content information, extracting a summarized image of the content according to a rule which corresponds to the content by analyzing the caption information, and transmitting the summarized image of content to the display apparatus.

### CROSS-REFERENCE TO RELATED APPLICATIONS

This application claims priority from Korean Patent Application No. 10-2013-0122142, filed in the Korean Intellectual Property Office on Oct. 14, 2013, the disclosure of which is incorporated herein by reference, in its entirety.

### BACKGROUND

1. Technical Field

Aspects of the exemplary embodiments relate to a content summarization server, a content providing system, and a method of summarizing a content. More particularly, the exemplary embodiments relate to a content summarization server which summarizes a content based on a content caption, a content providing system, and a method for summarizing a content.

2. Description of the Related Art

In response to a user watching an image content which is broadcast in real time from a half point of the content, the user may want to check the previous content which has already been broadcast. For example, in response to a user starting to watch a soccer content from a half point of the content, the user may want to know who has scored a goal in the previous content, and how the goal was scored.

In order to check the previously-broadcast content, a user has to search the Internet or watch a rerun of the content at a later date, which causes the user to be inconvenienced. In order to resolve this problem, a method of providing a summary of the previously-broadcast content has been provided.

The method for providing a summary of content in the related art is provided by extracting main scenes of the content (for example, a goal scene of soccer content, and a homerun scene of baseball content) using image information or voice information or a combination of both.

However, analyzing a content using image information or voice information requires a large amount of content information and thus, requires a large amount of signal processing, thereby slowing down the processing speed.

### SUMMARY

An aspect of the exemplary embodiments relates a content summarization server which summarizes a content using caption information related to the content, a content providing system, and a method for summarizing a content.

A method of summarizing a content in a content summarization server according to an exemplary embodiment includes receiving information regarding a content for which a content summary request is received from a display apparatus, in response to a content summary request being input from a user, acquiring caption information related to a content for which the content summary request is input, based on the received content information, extracting a summarized image of the content according to a rule which corresponds to the content by analyzing the caption information, and transmitting to the display apparatus the summarized image of content.

The method may further include determining a genre related to a content for which the content summary request is input. The rule which corresponds to the content may be determined according to the genre of the content.

The content information may include channel information and title information, and the determining may include determining the genre of the content by comparing the content information and EPG information stored in the content summarization server, or determining the genre of the content by analyzing the acquired caption information.

In response to the genre of the content being sport, the extracting may include extracting a summary template related to a content according to a rule which corresponds to the sport content using the caption information, extracting information regarding a sport content which corresponds to the extracted summary template, and generating a content summary image by mapping the extracted summary template and the extracted sport content.

The extracting a content summary template may include acquiring genre and team information of the sport content, extracting a keyword which corresponds to the genre of the sport content, and extracting an image including the keyword as a summary template, using the caption information.

The genre and team information of the sport content may be acquired by using at least one of metadata and caption information received from the display apparatus.

The extracting information regarding the sport content may include extracting at least one of player information, team information and environment information which corresponds to the summary template from image information and caption information of the summary template.

The acquiring may include acquiring caption information related to the content from an external caption server, acquiring caption information of the content by recognizing audio of the content through an external voice recognition server, or acquiring caption information of the content by analyzing an image of the content through optical character recognition (OCR).

A content summarization server according to an exemplary embodiment includes a communicator configured to perform communication with an external apparatus and a controller configured to control the communicator to acquire caption information related to a content for which the content summary request is input based on the received content information in response to information regarding a content for which a content summary request is input being received from a display apparatus, extract a summarized image of the content according to a rule which corresponds to the content by analyzing the caption information, and transmit the summarized image of content to the display apparatus.

The controller may determine a genre related to a content for which the content summary request is input, and the rule which corresponds to the content may be determined according to the genre of the content.

The content information may include channel information and title information, and the controller may determine the genre of the content by comparing the content information and EPG information stored in the content summarization server, or determine the genre of the content by analyzing the acquired caption information.

In response to the genre of the content being sport, the controller may extract a summary template related to a content according to a rule which corresponds to the sport content using the caption information, extract information regarding a sport content which corresponds to the extracted summary template, and generate a content summary image by mapping the extracted summary template and the extracted sport content.

The controller may acquire genre and team information of the sport content, extract a keyword which corresponds to the genre of the sport content, and extract an image including the keyword as a summary template using the caption information.

The genre and team information of the sport content may be acquired using at least one of metadata and caption information received from the display apparatus.

The controller may extract at least one of player information, team information and environment information which corresponds to the summary template from image information and caption information of the summary template.

The controller may acquire caption information related to the content from an external caption server, acquire caption information related to the content by recognizing audio of the content through an external voice recognition server, or acquire caption information related to the content by analyzing an image of the content through optical character recognition (OCR).

A method of summarizing a content of a content providing system according to an exemplary embodiment includes transmitting information regarding a content for which the content summary request is input to a content summarization server by a display apparatus in response to a content summary request being input from a user, acquiring caption information of a content for which the content summary request is input based on the content information received by the content summarization server, extracting a summarized image of the content according to a rule which corresponds to the content by analyzing the caption information by the content summarization server, transmitting the summarized image related to the content to the display apparatus by the content summarization server, and displaying the summarized image of the content by the display apparatus.

An aspect of an exemplary embodiment may provide a content summarization server, including: a controller configured to receive an input requesting content summary information, acquire caption information related to the content based on received content information, extract a summarized image of the content according to a rule which corresponds to the content by analyzing the caption information, transmit the summarized image of content to a display apparatus, and determine a genre related to a content for which the content summary request is input, wherein the rule which corresponds to the content is determined according to the genre of the content.

The content summarization server may further include a display configured to display the summarized image of the content.

The content summarization server may further include a communicator configured to perform communication with an external apparatus, wherein the communicator is controlled by the controller.

The content information may include channel information and title information, and wherein the controller is configured to determine the genre of the content by comparing the content information with EPG information stored in the content summarization server, or determines the genre of the content by analyzing the acquired caption information.

### BRIEF DESCRIPTION OF THE DRAWINGS

The above and/or other aspects will be more apparent by describing certain exemplary embodiments with reference to the accompanying drawings, in which:

FIG. 1 is a view which illustrates a content providing system, according to an exemplary embodiment;

FIG. 2 is a block diagram which illustrates a configuration of a display apparatus, according to an exemplary embodiment;

FIGS. 3A to 3C are views provided to explain an exemplary embodiment where a display apparatus displays a summarized image of content, according to an exemplary embodiment;

FIG. 4 is a block diagram which illustrates a configuration of a content summarization server, according to an exemplary embodiment;

FIG. 5 is a view which illustrates a module stored in a storage of a content summarization server, according to an exemplary embodiment;

FIG. 6 is a flowchart provided to explain a method of summarizing a content of a content summarization server, according to an exemplary embodiment; and

FIG. 7 is a sequence view provided to explain a method of summarizing a content of a content providing system, according to an exemplary embodiment.

### DETAILED DESCRIPTION OF THE EXEMPLARY EMBODIMENTS

It should be observed the method steps and system components have been represented by conventional symbols in the figure, showing only specific details which are relevant for an understanding of the exemplary embodiments. Further, details may be readily apparent to person ordinarily skilled in the art may not have been disclosed. In the exemplary embodiments, relational terms such as first and second, and the like, may be used to distinguish one entity from another entity, without necessarily implying any actual relationship or order between such entities.

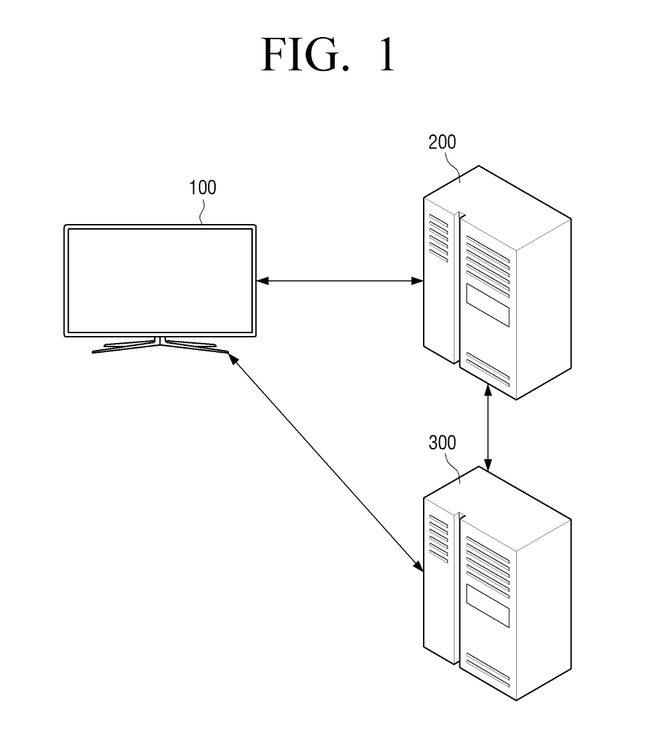

FIG. 1 is a view which illustrates a content providing system 10 according to an exemplary embodiment. As illustrated in FIG. 1, the content providing system 10 includes a display apparatus 100, a content summarization server 200 and a voice recognition server 300. In this case, the display apparatus 100 may be implemented as a smart television, but this is only an example. The display apparatus 100 may also be implemented as a display apparatus such as a smart phone, a tablet PC, a notebook PC, a desktop PC, etc.

The display apparatus 100 displays a content. In this case, the content may be a broadcast content which is played in real time and in particular, the content may be a content related to sports.

In response to a command to summarize a content being input from a user while the content is being displayed, the display apparatus 100 checks information related to the content which is currently displayed and transmits the content information and the content summarization command to the content summarization server 200. In this case, the content information may include a title of the content, an ID, channel information, etc.

The content summarization server 200 acquires caption information based on the content information received from the display apparatus 100. In this case, the content summarization server 200 may receive caption information related to the corresponding content from a caption server. In addition, the content summarization server 200 may acquire caption information by transmitting audio data related to the corresponding content through the voice recognition server 300. In addition, the content summarization server 200 may acquire caption information by analyzing image data of the corresponding content using OCR recognition.

The content summarization server 200 may analyze the acquired caption information and may extract a summarized image of content according to a rule which corresponds to the content.

Specifically, the content summarization server 200 may determine the genre of the content for which the content summarization request is input. In this case, the content summarization server 200 may determine the genre of the content by comparing the content information received from the display apparatus 100 and pre-stored EPG information, and determine the genre of the content by analyzing the acquired caption information.

In addition, the content summarization server 200 may generate a summarized image of content from a pre-stored content image by analyzing a caption according to a rule which is set according to the analyzed genre of the content.

In particular, in response to the genre of the content being sport, the content summarization server 200 may extract a summary template of the content from a pre-stored content image according to a rule which corresponds to a sport content using caption information. For example, in response to the genre of the content being the sport of soccer, the content summarization server 200 may analyze caption information and extract a screen corresponding to a caption which includes soccer-related terms which are frequently used in a soccer content such as “goal, assist, free kick, etc.” as a summary template.

In addition, the content summarization server 200 may extract information regarding a sport content which corresponds to the extracted summary template. For example, in response to the genre of the content being soccer, the content summarization server 200 may extract player information, team information, and environment information included in the extracted summary content.

Subsequently, the content summarization server 200 may generate a summarized image of content by mapping the extracted summary template and the extracted information regarding the sport content.

The content summarization server 200 may transmit the generated content summarization image to the display apparatus 100, and the display apparatus 100 may display the content summarization image along with the content which is currently displayed.

As described above, with the content providing system 10, a user may be provided with a summary service regarding the part of a real-time broadcast content which the user has not watched.

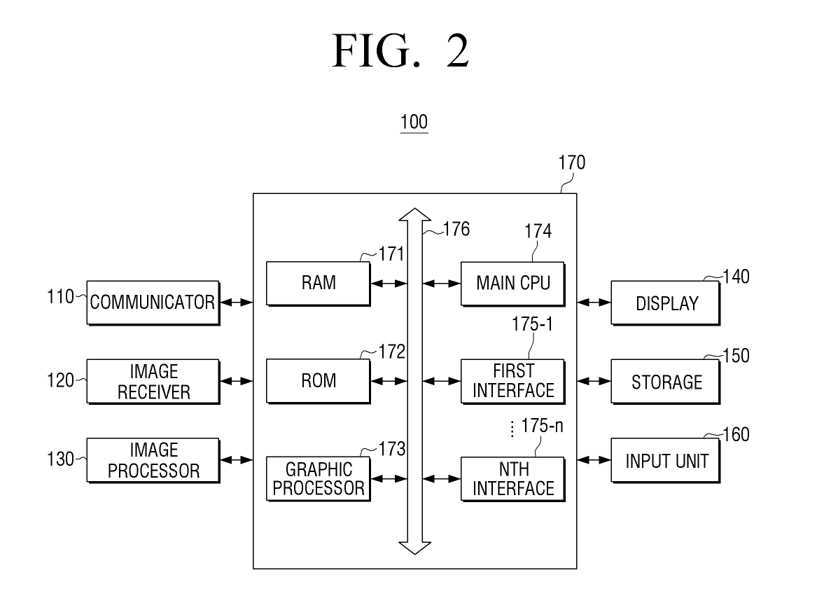

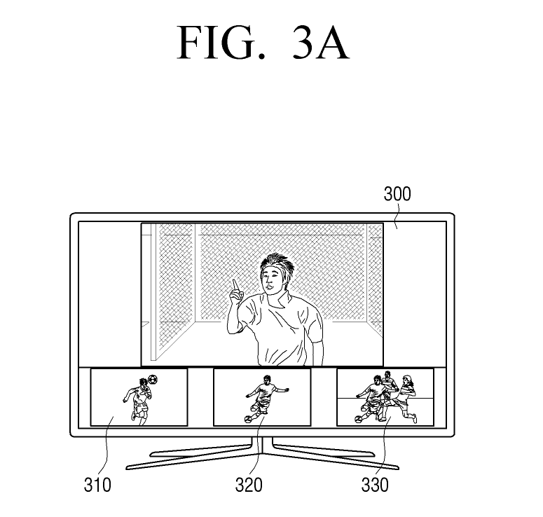

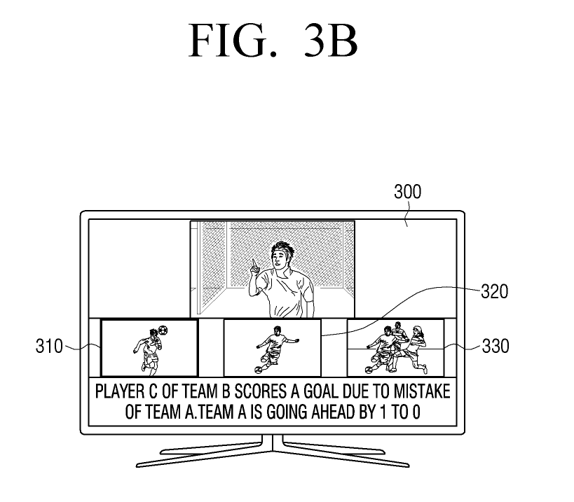

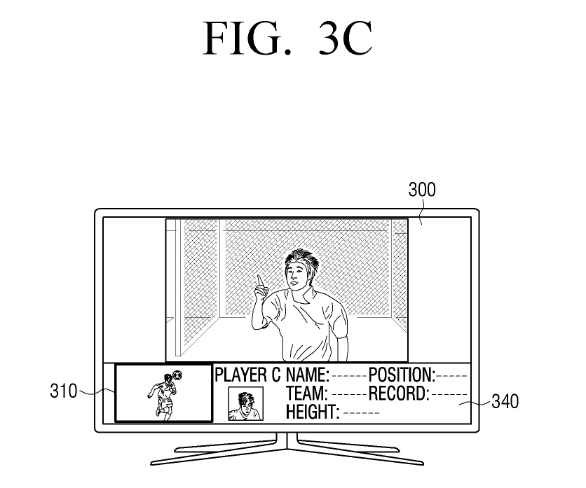

Hereinafter, the display apparatus 100 according to an exemplary embodiment will be described with reference to FIGS. 2 to 3C.

As illustrated in FIG. 2, the display apparatus 100 includes a communicator 110, an image receiver 120, an image processor 130, a display 140, a storage 150, and an input unit 160. The configuration of the display apparatus 100 of FIG. 2 is to perform various functions such as an image providing function, an image summary service providing function, etc. Thus, in response to another function being added to the display apparatus 100, the configuration illustrated in FIG. 2 may be changed, or a new configuration may be added.

The communicator 110 is an element which performs communication with an external apparatus in various genres according to various genres of communication methods. The communicator 110 may include various communication chips such as a WiFi chip, a Bluetooth® chip, a Near Field Communication (NFC) chip, a wireless communication chip, etc. In this case, the WiFi chip, the Bluetooth® chip, and the NFC chip perform communication according to a WiFi method, a Bluetooth® method, and an NFC method, respectively. The NFC chip refers to a chip which operates according to an NFC method by using 13.56 MHz from among various RF-ID frequency bands such as 135 kHz, 13.56 MHz, 433 MHz, 860˜960 MHz, 2.45 GHz, and so on. In response to the WiFi chip or the Bluetooth chip being used, various connection information such as SSID, session key, etc. is received/transmitted in advance so that various information can be received/transmitted using the same. The wireless communication chip refers to a chip which performs communication according to various communication standards such as IEEE®, Zigbee®, 3rd Generation (4G), 3rd Generation Partnership Project (3GPP), Long Term Evolution (LTE), and so on.

In particular, the communicator 110 may transmit content information and a content summary request to the external content summarization server 200, and may receive a summarized image of content from the content summarization server 200.

In case of an exemplary embodiment where the display apparatus 100 directly acquires caption information using voice recognition, the communicator 110 may transmit audio data of the content to the external voice recognition server 200 and receive text data which corresponds to the audio data of the content.

The image receiver 120 receives an image from various external apparatuses. In particular, the image receiver 120 may receive a broadcast content from an external broadcast directed to an image content from an external apparatus (for example, a DVD apparatus, etc.), and an image content stored in the storage 150.

The image processor 130 performs an image processing job such that the display 140 may display an image acquired through the image receiver 120. In particular, the image processor 130 may perform processing such that at least one summarized of content received from the content summarization server 200 may be displayed along with the image which is currently displayed.

The display 140 displays an image which is processed by the image processor 130. In addition, the display 140 may display a summarized image of content received from the content summarization server 200 along with an image content, which will be described later with reference to FIGS. 3A to 3C.

The storage 150 stores various modules to drive the display apparatus 100. For example, the storage 150 may store software including a base module, a sensing module, a communication module, a presentation module, a web browser module, and a service module. In this case, the base module refers to a basic module which processes a signal transmitted from each element of hardware included in the display apparatus 100, and transmits the processed signal to an upper layer module. The sensing module is a module which collects information from various sensors, and analyzes and manages the collected information. The sensing module may include a face recognition module, a voice recognition module, a motion recognition module, and an NFC recognition module, and so on. The presentation module is a module to compose a display screen. The presentation module includes a multimedia module for reproducing and outputting multimedia contents, and a UI rendering module for UI and graphic processing. The communication module is a module to perform communication with outside the apparatus. The web browser module refers to a module which accesses a web server by performing web-browsing. The service module is a module including various applications for providing various services.

As described above, the storage 150 may include various program modules, but some of the various program modules may be omitted, changed, or added according to the type and attribute of the display apparatus 100. For example, in response to the display apparatus 100 being implemented as a tablet PC, the base module may further comprise a location determination module to determine a GPS-based location, and the sensing module may further comprise a sensing module to detect a user motion.

In addition, the storage 150 may store Electronic Program Guide (EPG) information related to broadcast content.

The input unit 160, e.g. a user input, receives a user command to control the display apparatus 100. In particular, the input unit 160 may receive a user command to request for summarizing a content.

The input unit 160 may be realized as a remote controller, but this is only an example. The input unit 160 may be realized as various input apparatuses such as a motion input apparatus, a pointing device, a mouse, a keyboard, etc.

The controller 170 may control overall operations of the display apparatus 100. In this case, as illustrated in FIG. 2, the controller 170 includes RAM 171, ROM 172, a graphic processor 173, a main CPU 174, and the first to the nth interfaces 175-1˜175-n, and a bus 176. In this case, the RAM 171, the ROM 172, the graphic processor 173, the main CPU 174, and the first to the nth interfaces 175-1˜175-n may be connected to each other through the bus 176.

The ROM 172 stores a set of commands for system booting. In response to a turn-on command being input and power being supplied, the main CPU 174 copies an O/S stored in the storage 150 in the RAM 171 according to the command stored in the ROM 172 and executes the O/S to boot the system. In response to the booting being completed, the main CPU 174 copies various application programs stored in the storage 150 in the RAM 171 and executes various programs copied in the RAM 171 in order to perform various operations

The graphic processor 173 generates a screen which includes various objects such as an icon, an image, and a text using a computing unit (not shown) and a renderer (not shown). The computing unit computes property values such as coordinates, shape, size, and color of each object to be displayed according to the layout of the screen. The renderer generates a screen with various layouts including objects based on the property values computed by the computing unit. The screen generated by the renderer is provided to the display 140 and displayed within a display area.

The main CPU 174 accesses storage 150, and performs a booting operation using an operating system (O/S) stored in the storage 150. In addition, the main CPU 174 performs various operations using various programs, contents, data, etc. stored in the storage 150.

The first to the nth interfaces 175-1˜175-n are connected to the above-described various elements. One of the interfaces may be a network interface which is connected to an external apparatus via network.

In particular, in response to a content summary request being input through the input unit 160 while a specific content is being displayed, the controller 170 may control the communicator 110 to check content information stored in the storage 150 and transmit the checked content information and the content summary request to the external content summarization server 200. In this case, the content information may be the title, ID, and channel information of the content which is currently displayed, but is not limited thereto.

In response to a summarized image of content being received from the content summarization server 200, the controller 170 may control the image processor 130 and the display 140 to display the received summarized image of content along with the content which is currently displayed. Specifically, as illustrated in FIG. 3A, the controller 170 may control the display 140 to display a content 300 and display a plurality of summarized images of contents 310, 320, 330 at the lower part of the content 300. In this case, the plurality of summarized images of contents 310, 320, 330 may be arranged according to the order of time.

In response to one of the plurality of summarized images of contents 310, 320, 330 being selected through the input unit 160, the controller 170 may control the display 140 to display text information regarding the selected image as well. For example, in response to the first summarized image of content 310 being selected from among the plurality of summarized images of contents 310, 320, 330, the controller 170 may control the display 140 to highlight the first summarized image of content 310 and also display text information, “Player C of team B scores a goal due to the mistake of team A, so team B is going ahead of team B by a score of 1 to 0” as illustrated in FIG. 3B.

In addition, as illustrated in FIG. 3B, in response to a selection command being input again while the first summarized image of content 310 is highlighted, the controller 170 may control the display 140 to display detailed information 340 regarding player C, which is information related to the first summarized image of content 310 as illustrated in FIG. 3C.

As described above, by using the content summary service, a user may more intuitively check a summarized content of the part of the content which the user has not watched.

In the above exemplary embodiment, the content summarization server 200 rather than the display apparatus 100 acquires caption information of content, but this is only an example. The display apparatus 100 may directly acquire caption information and transmit the caption information to the content summarization server 200. Specifically, the display apparatus 100 may separate caption information included in an image content and transmit the caption information to the content summarization server 200, and after acquiring the caption information using voice recognition or OCR recognition, transmit the caption information to the external content summarization server 200.

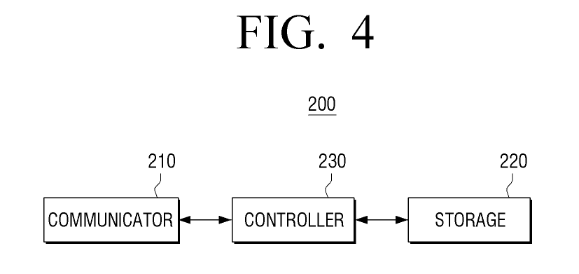

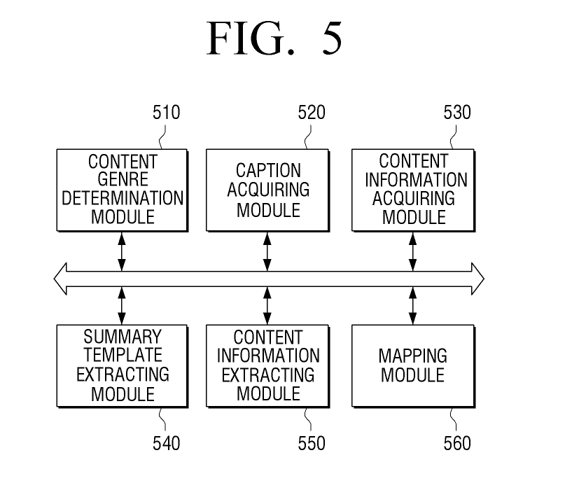

Hereinafter, the content summarization server 200 according to an exemplary embodiment will be described with reference to FIGS. 4 and 5.

FIG. 4 is a block diagram which illustrates a configuration of the content summarization server 200 according to an exemplary embodiment. As illustrated in FIG. 4, the content summarization server 200 includes a communicator 210, a storage 220 and a controller 230.

The communicator 210 performs communication with an external apparatus of various genres according to a communication method of various genres. In particular, the communicator 210 may perform communication with an external apparatus using wireless communication such as WiFi communication, etc.

In addition, the communicator 210 may perform communication with the external display apparatus 100. In particular, the communicator 210 may receive content information and a content summary request from the display apparatus 100. In addition, the communicator 210 may directly receive caption information from the display apparatus 100.

In response to caption information being acquired by using voice recognition, the communicator 210 may transmit audio data related to a content to the voice recognition server 200, and may receive the text information acquired through voice recognition from the voice recognition server 200.

The storage 220 stores a program and data to control the content summarization server 200. The description regarding various modules for the content summarization server 200 to provide a content summary service will be provided with reference to FIG. 5.

As illustrated in FIG. 5, the storage 220 includes a content genre determination module 510, a caption acquiring module 520, a content information acquiring module 530, a summary template extracting module 540, a content information extracting module 550, and a mapping module 560.

The content genre determination module 510 determines the genre related to a content for which a content summary request is input. Specifically, the content genre determination module 510 may determine the genre related to a content based on content information included in metadata received from the display apparatus 100. In response to the content genre information not being included in the received content information, the content genre determination module 510 may determine the genre of the content by comparing pre-stored EPG information with the content information (for example, a title). Further, the content genre determination module 510 may determine the genre of the content by analyzing caption information. For example, the content genre determination module 510 may analyze words included in caption information, and in response to a lot of words like “assist, free kick, goal, left foot, right foot, etc” being included, may determine that the genre of the content as being related to soccer content.

The caption acquiring module 520 acquires caption information regarding a content for which a content summary request is input. Specifically, the caption acquiring module 520 may acquire pre-stored caption information which corresponds to the content for which a content summary request is input. In addition, the caption acquiring module 520 may acquire caption information by transmitting audio data of a pre-stored content to the voice recognition server 300. Further, the caption acquiring module 520 may acquire caption information by performing OCR recognition with respect to image data of a pre-stored content.

The content information acquiring module 530 acquires content information from the display apparatus 100. In addition, the content information acquiring module 530 may acquire content information from an external content information providing server. In this case, the content information may include a content title, an ID, channel information, a play time, etc.

The summary template extracting module 540 may extract a summary template related to a content according to a rule which corresponds to the content for which a content summary request is input using caption information. Specifically, the summary template extracting module 540 may extract a keyword which corresponds to a content genre. For example, the summary template extracting module 540 may extract a keyword which can be included in main scenes of a soccer game such as “goal, free kick, penalty kick, assist, corner kick, etc.” as a keyword which corresponds to a soccer content. In addition, the summary template extracting module 540 may extract a scene including the keyword from among pre-stored contents as a summary template using caption information.

The content information extracting module 550 may extract information of a sport content which corresponds to a summary template. Specifically, the content information extracting module 550 may extract at least one of player information, team information and environment information which corresponds to a summary template from image information and caption information of the summary template. For example, in response to player A scoring a goal in the first summary template, the content information extracting module 550 may extract information regarding player A. In this case, the content information extracting module 550 may acquire information regarding player A from an external server.

The mapping module 560 generates one content summary image by mapping a summary template extracted from the summary template extracting module 540 with information of the content extracted from the content information extracting module 550.

Referring back to FIG. 4, the storage 220 may store image data and audio data with respect to every content (particularly, a broadcast content). In addition, according to an exemplary embodiment, the storage 220 may also store caption data with respect to every content. Further, the storage 220 may store EPG information to determine the genre of a broadcast content.

The controller 230 may perform a content summary service by using various data and modules stored in the storage 220.

Specifically, in response to a content summary request and content information being received from the display apparatus 100 through the communicator 210, the controller 230 may determine the genre of the content for which the content summary request is input. In this case, the controller 230 may determine the content genre by using the content information received from the display apparatus 100, determine the content genre by comparing pre-stored EPG information and the content information, and determine the content genre by using caption information.

The controller 230 may acquire caption information by using caption information. The caption information may be pre-stored in the storage 220, but this is only an example. The controller 230 may acquire caption information by using the external voice recognition server 300 or an OCR recognition server.

In addition, the controller 230 may extract a summarized image of content from a pre-stored image content according to a rule which corresponds to the genre of the content which is determined by using caption information. In this case, the rule corresponding to a content may be determined according to the genre of the content. In particular, the rule which corresponds to the content may be a keyword which is frequently used in main scenes according to the genre of the content.

According to the exemplary embodiment, if the genre of the content is a sport, the controller 230 may extract a summary template of the content according to a rule which corresponds to a content related to a sport, using caption information.

Specifically, the controller 230 acquires the genre and team information of the sport content. In this case, the genre and team information of the sport content may be acquired using at least one of metadata and caption information which are received from the display apparatus 100. For example, in response to the metadata received from the display apparatus 100 includes information, “English premier league, team A vs. team B,” the controller 230 may acquire the genre and team information of the sport content from the metadata. In another example, in response to words like “soccer, league, right foot, team A, team B, goal, assist” being included in caption information for more than a predetermined number of times, the controller 230 may acquire the genre and team information from the caption information.

The controller 230 may extract a keyword corresponding to the genre of a sport content. For example, in response to the genre of a sport content being soccer, the controller 230 may extract keywords which are frequently used in main scenes of a soccer game such as “goal, assist, penalty kick, corner kick, free kick, score, save, etc.” as keywords. In another example, in response to the genre of a sport content being the sport of baseball, the controller 230 may extract keywords which are frequently used in main scenes of a baseball game such as “home-run, hit, two-base hit, three-base hit, base stealing, double play, etc.” as keywords.

In addition, the controller 230 may extract an image including a keyword as a summary template using caption information. Specifically, the controller 230 may determine whether a keyword is included in acquired caption information, and extract an image including the keyword as a summary template. For example, the controller 230 may extract an image where keywords such as “goal, assist, penalty kick, corner kick, free kick, goal, save, etc.” are included for more than predetermined times from among all content images as a summary template.

In this case, the controller 230 may compare keywords with caption information using a partial string matching method (for example, a Levenshtein distance method or n-gram analysis method) rather than an absolute string matching method.

In response to a summary template being extracted, the controller 230 may extract content information which corresponds to the extracted summary template. In this case, the controller 230 may extract at least one of player information which corresponds to the summary template, team information and environment information (for example, sports ground information, weather information, etc.) from the image information and caption information of the summary template. For example, in response to the extracted summary template being a goal scene, the controller 230 may determine the player who has scored a goal using the image information and caption information of the extracted summary template. In addition, the controller 230 may acquire information regarding the player who has scored a goal as content information which corresponds to the summary template.

Further, the controller 230 may generate a content summary image by mapping an extracted summary template and extracted sport content information. For example, in response to an extracted summary template being a goal scene, the controller 230 may map the summary template of the goal scene with information regarding a player who has scored a goal so as to generate a content summary image.

The controller 230 may control the communicator 210 to transmit a generated content summary image to the external display apparatus 100.

As described above, in response to a user watching a broadcast content which is broadcast in real time from a half point of the content, the user may check the previously-broadcast content very quickly through the content summarization server 200.

In the above exemplary embodiment, an assumption is made that the genre of content is a sport, but this is only an example. The technical feature of the exemplary embodiments may also be applied to other contents (for example, a news content, a music broadcast content, a movie content, etc.).

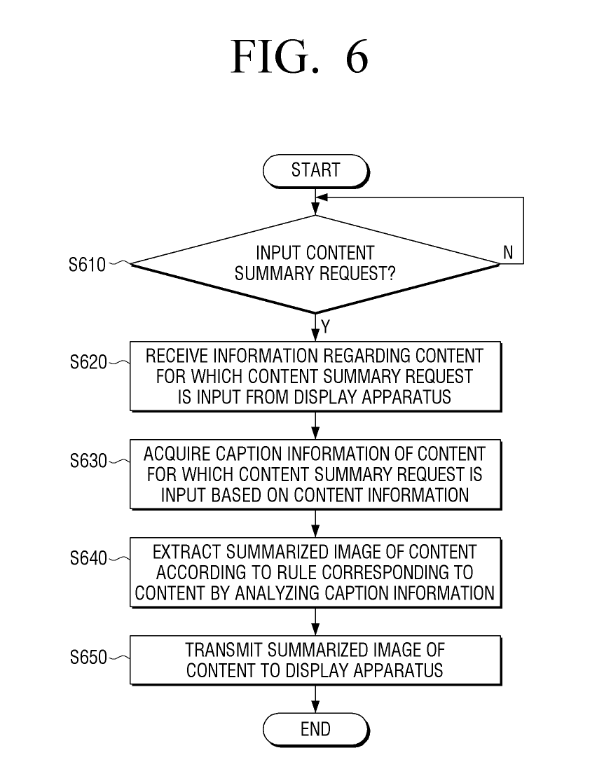

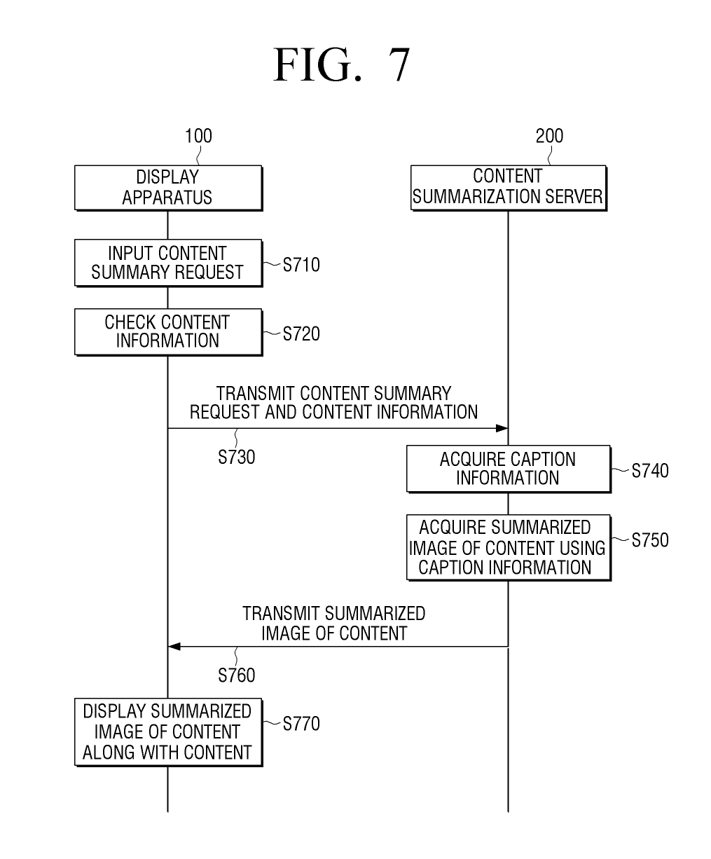

Hereinafter, a method for summarizing a content will be described with reference to FIGS. 6 and 7. FIG. 6 is a flowchart provided to explain a method of summarizing a content of the content summarization server 200 according to an exemplary embodiment.

First, a determination is made as to whether a content summary request is input from a user of the display apparatus 100 (S610).

In response to a content summary request being input (5610-Y), the content summarization server 200 receives from the display apparatus 100 information regarding a content for which the content summary request is input (S620). In this case, the content information may include at least one of title, ID, channel information, and play time information related to the content.

Subsequently, the content summarization server 200 acquires caption information of the content for which the content summary request is input based on the content information (S630). In this case, the content summarization server 200 may acquire caption information from metadata received from the display apparatus 100 or through a voice recognition server or OCR recognition.

The content summarization server 200 extracts a summarized image of content according to a rule which corresponds to the content by analyzing the caption information (S640). Specifically, the content summarization server 200 may check the genre of the content, and extract the summarized image of content according to a rule (for example, a keyword) which is determined based on the genre of content using caption information. For example, the content summarization server 200 may determine whether a keyword which corresponds to a sport content is included by using caption information, and extract an image frame where the keyword is included for more than predetermined times as a content summary image.

Subsequently, the content summarization server 200 transmits the content summary image to the display apparatus 100 (S650).

FIG. 7 is a sequence view provided to explain a method for summarizing a content of the content providing system 10 according to an exemplary embodiment.

The display apparatus 100 receives a content summary request (S710). In this case, the display apparatus 100 may receive a content summary request through an input apparatus such as a remote controller.

The display apparatus 1000 checks information regarding a content for which the content summary request is input (S720). In this case, the content information may include at least one of title, ID, channel information, and play time information of the content.

The display apparatus 100 transmits the content summary request and the content information to the content summarization server 200 (S730). In this case, the display apparatus 100 may also transmit caption information.

The content summarization server 200 acquires caption information of the content for which the content summary request is input based on the content information (S740). In this case, the content summarization server 200 may acquire caption information directly from the display apparatus 100. However, this is only an example, and the content summarization server 200 may acquire caption information through the voice recognition server 300 by using audio data of pre-stored contents, and may acquire caption information through OCR recognition by using image data of pre-stored contents.

The content summarization server 200 acquires a summarized image of content using the caption information (S750). Specifically, the content summarization server 200 determines the genre of the content based on the content information, and checks a rule which corresponds to the content genre. Subsequently, as illustrated in FIGS. 4 and 5, the content summarization server 200 may extract a summarized image of content according to the rule which corresponds to the content genre using the caption information.

The content summarization server 200 transmits the extracted summarized image of content (S760).

The display apparatus 100 displays the summarized image of content along with the content (S770). In this case, the display apparatus 100 may provide the image with the content summary image using the method which is described above, with reference to FIGS. 3A to 3C.

According to the above-described method for summarizing a content, in response to a user watching a broadcast content which is broadcast in real time from a half point of the content, the user may check the previously-broadcast content more quickly through a summarized image of content.

Meanwhile, in the above exemplary embodiment, an assumption is made that the display apparatus 100 displays a summarized image of content using the content summarization server 200 which is provided separately, but this is only an example. The display apparatus 100 may have the function of the content summarization server 200 therein.

In the above exemplary embodiment, voice recognition is performed through the voice recognition server 300 which is provided separately, but this is only an example. A voice recognition module may be included directly in the display apparatus 100 or the content summarization server 200.

The method for summarizing a content according to the above-described various exemplary embodiments may be implemented as a program and provided in a display apparatus. In this case, the program including the content summarizing method may be provided through a non-transitory computer readable storage medium.

The method for recognizing a content in a display apparatus according to the above-described various exemplary embodiments may be implemented as a program and provided in the display apparatus. In this case, a program including the method of recognizing a content in a display apparatus may be provided through a non-transitory computer readable storage medium.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray Disc™, USB, memory card, and ROM and provided therein.

The foregoing exemplary embodiments and advantages are merely exemplary and are not to be construed as limiting. The present teachings can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of summarizing a content in a content summarization server, the method comprising:
receiving information regarding a content for which a content summary request is received from a display apparatus in response to a content summary request being input from a user;
acquiring caption information related to a content for which the content summary request is input based on the received content information;
extracting a summarized image of the content according to a rule which corresponds to the content by analyzing the caption information; and
transmitting to the display apparatus the summarized image of content.

2. The method as claimed in claim 1, further comprising:
determining a genre related to a content for which the content summary request is input,
wherein the rule which corresponds to the content is determined according to the genre of the content.

3. The method as claimed in claim 2, wherein the content information includes channel information and title information,
wherein the determining comprises determining the genre of the content by comparing the content information and EPG information stored in the content summarization server, or determining the genre of the content by analyzing the acquired caption information.

4. The method as claimed in claim 2, wherein in response to the genre of the content being a sport, the extracting comprises:
extracting a summary template related to a content according to rule which corresponds to the sport content using the caption information;
extracting information regarding the sport content which corresponds to the extracted summary template; and
generating a content summary image by mapping the extracted summary template and the extracted sport content.

5. The method as claimed in claim 4, wherein the extracting a content summary template comprises:
acquiring genre and team information related to the sport content;
extracting a keyword which corresponds to the genre of the sport content; and
extracting an image which includes the keyword as a summary template using the caption information.

6. The method as claimed in claim 5, wherein the genre and team information of the sport content is acquired using at least one of metadata and caption information received from the display apparatus.

7. The method as claimed in claim 5, wherein the extracting information regarding the sport content comprises extracting at least one of player information, team information and environment information which corresponds to the summary template from image information and caption information of the summary template.

8. The method as claimed in claim 1, wherein the acquiring comprises acquiring caption information related to the content from an external caption server, acquiring caption information of the content by recognizing audio related to the content through an external voice recognition server, or acquiring caption information related to the content by analyzing an image of the content through optical character recognition (OCR).

9. A content summarization server, comprising:
a communicator configured to perform communication with an external apparatus; and
a controller configured to control the communicator to acquire caption information related to a content for which a content summary request is input based on received content information in response to information regarding a content for which a content summary request is input being received from a display apparatus, extract a summarized image of the content according to a rule which corresponds to the content by analyzing the caption information, and transmit the summarized image of content to a display apparatus.

10. The server as claimed in claim 9, wherein the controller is configured to determine a genre related to a content for which the content summary request is input,
wherein the rule which corresponds to the content is determined according to the genre of the content.

11. The server as claimed in claim 10, wherein the content information includes channel information and title information,
wherein the controller is configured to determine the genre of the content by comparing the content information with EPG information stored in the content summarization server, or determines the genre of the content by analyzing the acquired caption information.

12. The server as claimed in claim 10, wherein the controller is configured to extract a summary template related to a content according to rule corresponding to the sport content using the caption information in response to the genre of the content being a sport, information regarding a sport content which corresponds to the extracted summary template, and generate a content summary image by mapping the extracted summary template and the extracted sport content.

13. The server as claimed in claim 12, wherein the controller is configured to acquire genre and team information of the sport content, extract a keyword which corresponds to the genre of the sport content, and extract an image including the keyword as a summary template using the caption information.

14. The server as claimed in claim 13, wherein the genre and team information of the sport content is acquired using at least one of metadata and caption information received from the display apparatus.

15. The server as claimed in claim 13, wherein the controller is configured to extract at least one of player information, team information and environment information which corresponds to the summary template from image information and caption information of the summary template.

16. The server as claimed in claim 9, wherein the controller is configured to acquire caption information of the content from an external caption server, acquire caption information related to the content by recognizing audio of the content through an external voice recognition server, or acquires caption information related to the content by analyzing an image of the content through optical character recognition (OCR).

17. A method for summarizing a content of a content providing system, the method comprising:
transmitting information regarding a content for which the content summary request is input to a content summarization server by a display apparatus in response to a content summary request being input from a user;
acquiring caption information related to a content for which the content summary request is input based on the received content information by the content summarization server;
extracting a summarized image related to the content according to a rule which corresponds to the content by analyzing the caption information by the content summarization server;
transmitting the summarized image related to the content to the display apparatus by the content summarization server; and
displaying the summarized image of the content by the display apparatus.

18. A content summarization server, comprising:
a display configured to display the summarized image of the content; and
a controller configured to receive an input requesting content summary information, acquire caption information related to the content based on received content information, extract a summarized image of the content according to a rule which corresponds to the content by analyzing the caption information, transmit the summarized image of content to a display apparatus, and determine a genre related to a content for which the content summary request is input,
wherein the rule which corresponds to the content is determined according to the genre of the content.

19. The content summarization server of claim 18, further comprising a communicator configured to perform communication with an external apparatus, wherein the communicator is controlled by the controller.

20. The content summarization server of claim 18, wherein the content information includes channel information and title information, and
wherein the controller is configured to determine the genre of the content by comparing the content information with EPG information stored in the content summarization server, or determine the genre of the content by analyzing the acquired caption information.
